(19) United States
(12) Patent Application Publication
(10) Pub. No.: US 2006/0045524 A1
(43) Pub. Date: Mar. 2, 2006

(54) Optical access network of wavelength division method and passive optical network using the same

(75) Inventors: Gyu-Woong Lee, Suwon-si (KR); Jae-Hoon Lee, Seoul (KR); Yong-Gyoo Kim, Seoul (KR); Yun-Je Oh, Yongin-si (KR); Seong-Taek Hwang, Pyeongtaek-si (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/156,155

(22) Filed: Jun. 17, 2005

(30) Foreign Application Priority Data
Aug. 28, 2004 (KR) 2004-68215

(51) Int. Cl. H04J 14/00

(52) U.S. Cl. 398/71

(57) ABSTRACT

An optical access network of wavelength division method and passive optical network using the same are disclosed. The wavelength division multiplexed optical access network includes a central office for multiplexing first optical signals for wire communication and second optical signals for wireless communication and a remote node connected to the central office through an optical fiber and for demultiplexing a multiplexed optical signal received from the central office. A plurality of subscribers may be connected to the remote node. Each subscriber receives a first optical signal having a corresponding wavelength from among the demultiplexed first optical signals. The network also includes a plurality of radio relay stations connected to the remote node, each radio relay station converting a second optical signal having a corresponding wavelength from among the demultiplexed second optical signals into a radio electric signal and wirelessly transmitting the radio electric signal.

### CLAIM OF PRIORITY

This application claims priority to an application entitled “Optical Access Network of Wavelength Division Method And Passive Optical Network Using The same,” filed in the Korean Intellectual Property Office on Aug. 28, 2004 and assigned Serial No. 2004-68215, the contents of which are incorporated herein by reference.

### BACKGROUND OF THE INVENTION

1. Field of the Invention

The present invention relates to an optical access network, and more particularly to a wavelength division multiplexed optical access network capable of employing either/both a wire network and a wireless network.

2. Description of the Related Art

Access network, such as a wire communication system or a mobile communication system, must process data having wider band widths in order to provide various high-capacity multimedia data such as images, moving pictures, as well as voice signals. A wavelength division multiplexed (WDM) passive optical access network has been widely used as a communication network capable of processing broadband communication data.

FIG. 1 illustrates a conventional WDM optical access network 100. The conventional WDM optical access network 100 includes a central office (CO) 110 for detecting an upstream optical signal and generating a multiplexed downstream optical signal, a customer premise (CP) 130 for receiving a corresponding downstream optical signal and generating an upstream optical signal, and a remote node (RN) for relaying optical signals between the CO 110 and the CP 130.

The CO 110 includes a plurality of downstream transmitters 111-1 to 111-N for generating wavelength-locked downstream optical signals having their own wavelengths, a first multiplexer 113 for multiplexing the downstream optical signals, a downstream broadband light source 115 for generating downstream light for wavelength-locking the downstream transmitters 11-1˜111-N, a first demultiplexer 114 for demultiplexing multiplexed upstream optical signals, a plurality of upstream detectors 112-1 to 112-N for detecting corresponding demultiplexed upstream optical signals, and an upstream broadband light source for generating upstream light for wavelength-locking the CP 130.

The first multiplexer 113 is linked with the RN 120 through a downstream optical fiber 101. The first multiplexer 113 demultiplexes downstream light, which is input through a first circulator 116, into incoherent channels having their own wavelengths. The first multiplexer 113 allows the demultiplexed downstream light to be input to corresponding downstream light sources 111-1 to 111-N. The first multiplexer 113 multiplexes the downstream optical signals and outputs the multiplexed downstream optical signals to the RN 120 through the first circulator 116. The downstream light generated by the downstream broadband light source has a waveform shown in FIG. 2A and is input to the first multiplexer 113 through the first circulator 116. The first multiplexer 113 splits the downstream light to a plurality of incoherent channels having wavelengths in the form shown in FIG. 2B and outputs the split downstream light to corresponding downstream transmitter 111-1˜111-N.

The downstream transmitters 111-1 to 111-N may include a Fabri Perrot-Laser Diod (FP-LD) having a multi-mode output characteristic or a semiconductor optical amplifier (SOA). If the downstream transmitters 111-1˜111-N are the FP-LDs having the same output characteristic as shown in FIG. 2C, a wavelength-locked downstream signal having a wave form shown in FIG. 2D is generated. In the wavelength-locked downstream signal, only one mode corresponding to an incoherent channel wavelength having a waveform shown in FIG. 2B and being applied to corresponding downstream transmitters 111-1 to 111-N, is output from among multiple modes of the down transmitters 111-1 to 111-N.

The first demultiplexer 114 is linked with the RN 20 through an upstream optical fiber 102. The first demultiplexer 114 demulitplexes multiplexed upstream optical signals inputted through a second circulator 118 and outputs the multiplexed upstream optical signals to corresponding upstream detectors 112-1 to 112-N. The second circulator 118 is arranged between the RN 120 and the first demultiplexer 114. The second circulator 118 is connected to the upstream broadband light source 117, thereby outputting the upstream light to the RN 120.

The RN 120 includes a second demultiplexer 121 linked with the first multiplexer 113 through the downstream optical fiber 101 and a second multiplexer 122 linked with the first demultiplexer 114 through the upstream optical fiber 102.

The second demultiplexer 121 demultiplexes the multiplexed downstream optical signals and outputs the multiplexed downstream optical signals to the CP 130. The second multiplexer 122 demultiplexes the upstream light into incoherent channels having their own wavelengths, and outputs the upstream light to the CP 130. The CP 130 multiplexes wavelength-locked upstream optical signals and outputs the wavelength-locked upstream optical signals to the CO 110.

The CP 130 includes a plurality of upstream light sources 132-1 to 132-N linked with the second multiplexer 122 and a plurality of downstream detectors 131-1 to 131-N for detecting corresponding downstream optical signals demultiplexed by the second demultiplexer 121.

Each of the upstream light sources 132-1 to 132-N generates an upstream optical signals wavelength-locked by a corresponding incoherent channel and outputs the generated upstream optical signals to the second multiplexer 122.

However, for the above-described conventional optical access network, a great amount of initial investment costs is required.

In a wireless network, since mobility and point to multi-point connection are provided, serious loss may occur while limiting bandwidths. To overcome the this disadvantage, a radio-over-fiber technique has been used.

The radio-over-fiber technique is used for transmitting radio electric signals with a predetermined bandwidth through an optical fiber. A radio-over-fiber network includes a central office and a remote node linked with each other through an optical fiber. The central office converts a radio electric signal into an optical signal and transmits the converted optical signal to a corresponding remote node. The corresponding remote node converts a received optical signal into a radio electric signal and then transmits the converted radio electric signal to a neighbor wireless terminal.

The radio-over-fiber network can centralize electrical appliances, which have been distributed to a plurality of remote nodes, in a central office. Therefore, the remote node may include only optical transceivers and remote antenna units, signals can be transmitted through broadband widths, and frequency efficiencies can be enhanced.

However, since the conventional WDM optical access network provides services mainly for wire network subscribers, not only the network requires great amount of costs for initial investment for and maintenance of the network including optical fiber laying costs, but also extension/growth of the network market is restricted. In addition, since the radio-over-fiber network also requires a great amount of costs for, e.g., optical fiber laying costs, the spread and usage of the radio-over fiber network is restricted

Furthermore, as the use of various types of wireless terminals having various multimedia functions increases, the demand for the radio-over-fiber network capable of providing broad bands and high-speed wireless services will also increased. However, the radio-over-fiber network requires a great amount of costs for initial investment including optical fiber laying costs, and a lot of time is required in order to construct a dedicated radio-over-fiber network.

### SUMMARY OF THE INVENTION

One aspect of the present invention relates to a wavelength division multiplexed optical access network, which can offer broadband services to subscribers of wire and wireless networks at a ultra high speed while investment costs required for constructing the WDM optical access network is minimized.

tone embodiment of the present invention is directed to a wavelength division multiplexed optical access network including a central office for multiplexing first optical signals for wire communication and second optical signals for wireless communication, and a remote node connected to the central office through an optical fiber and for demultiplexing a multiplexed optical signal received from the central office. A plurality of subscribers may be connected to the remote node. Each subscriber receives a first optical signal having a corresponding wavelength from among the demultiplexed first optical signals. The network also includes a plurality of radio relay stations connected to the remote node, each radio relay station converting a second optical signal having a corresponding wavelength from among the demultiplexed second optical signals into a radio electric signal and wirelessly transmitting the radio electric signal.

### BRIEF DESCRIPTION OF THE DRAWINGS

The above and other aspects, features and embodiments of the present invention will be more apparent from the following detailed description taken in conjunction with the accompanying drawings, in which:

FIG. 1 illustrates a conventional WDM optical access network;

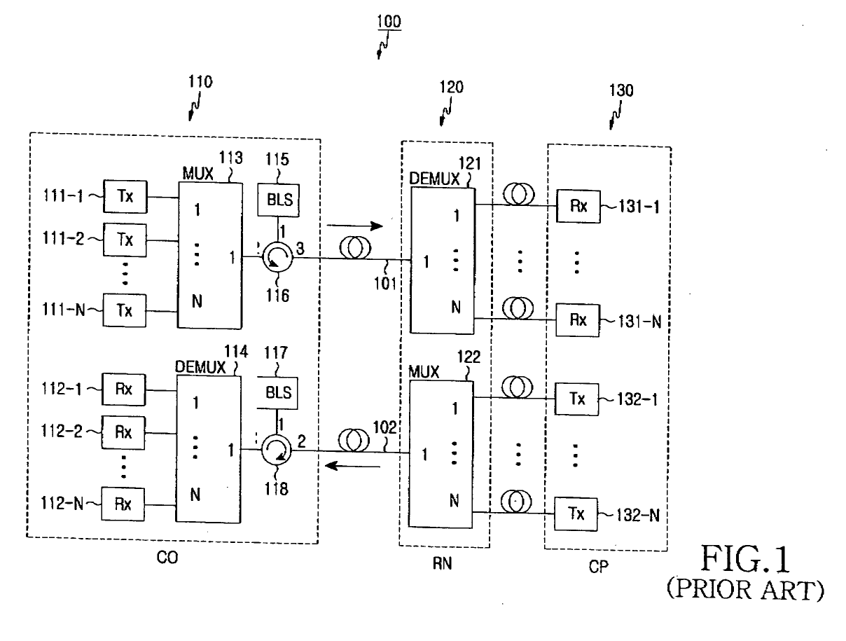

FIGS. 2A to 2D are graphs related to the WDM optical access network shown in FIG. 1;

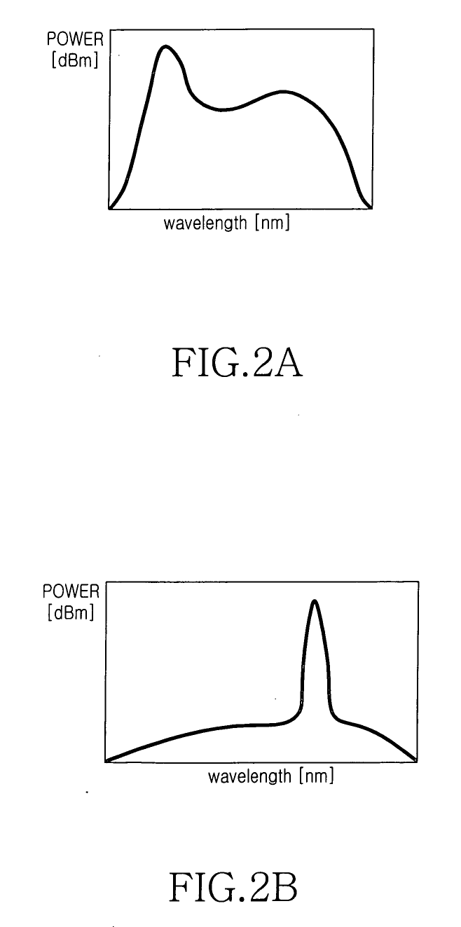

FIG. 3 illustrates an optical access network according to a first embodiment of the present invention;

FIGS. 4A to 4D are graphs related to the optical access network shown in FIG. 3;

FIG. 5A is a block diagram illustrating an electric-optical conversion part shown in FIG. 3;

FIG. 5B is a block diagram illustrating a radio relay station shown in FIG. 3;

FIG. 6 illustrates a passive optical access network according to a second embodiment of the present invention;

FIG. 7 is a graph showing a relationship between a broadband light source and a first band-allocation module and a second band-allocation module shown in FIG. 6;

FIG. 8 illustrates an example of a radio relay station shown in FIG. 6; and

FIG. 9 illustrates an example of a radio relay station shown in FIG. 6.

### DETAILED DESCRIPTION

Hereinafter, embodiments of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may obscure the subject matter of the present invention.

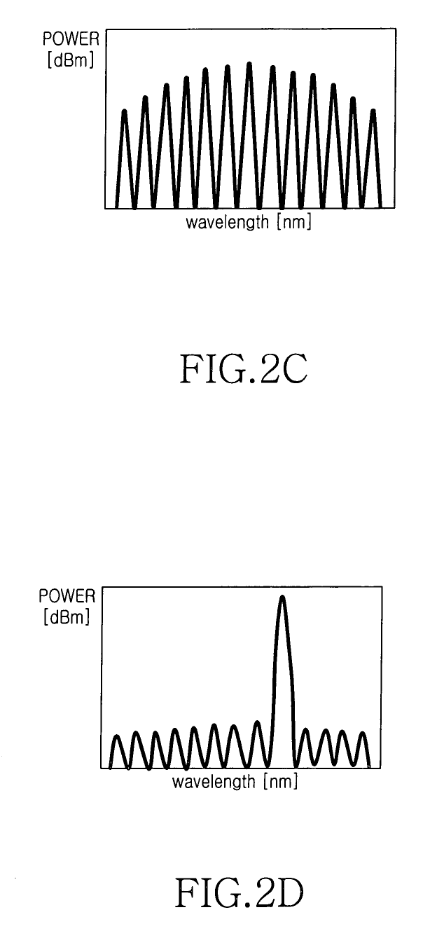

FIG. 3 illustrates an optical access network 200 according to a first embodiment of the present invention. The wavelength division multiplexed (WDM) optical access network 200 includes a central office (CO) 210 for multiplexing first optical signals 203 for wire communication and second optical signals 204 for wireless communication, a remote node (RN) 220 for demultiplexing a multiplexed optical signal 202 received from the CO 210, and a customer premise (CP) 230 for receiving the first optical signals 203 and the second optical signals 204 demultiplexed in the RN 220. The CP 230 includes a plurality of subscribers 231-1 to 213-N, each of which is connected to the RN 220, and a plurality of radio relay stations, each of which is connected to the RN 220.

The CO 210 includes a broadband light source 214 for generating light with broadband wavelengths, a multiplexer 213, a plurality of light sources 211-1 to 211-N for generating first optical signals 203 wavelength-locked by corresponding incoherent channels, a plurality of electric-optical conversion parts 212-1 to 212-N connected to the multiplexer 213 and for converting a radio electric signal into a second optical signal 204, a circulator 216, and a band-allocation module 215.

The multiplexer 213 multiplexes the first optical signals 203 and the second optical signals 204 and outputs the multiplexed optical signals to the RN 220 through the circulator 216. The multiplexer 213 demultiplexes the light 201 inputted through the circulator 216 into a plurality of incoherent channels having their own wavelengths (λ₁ to λ_{N}) and outputs the demultiplexed light to corresponding light sources 211-1 to 211-N. Each of the light sources 211-1 to 211-N generates the first optical signal 203 wavelength-locked by a corresponding incoherent channel and outputs the first optical signal 203 to the multiplexer 213.

The circulator 216 outputs an optical signal multiplexed by the multplexer 213 to the RN 220. The circulator 216 also outputs the light 201 generated from the broadband light source 214 to the multiplexer 213.

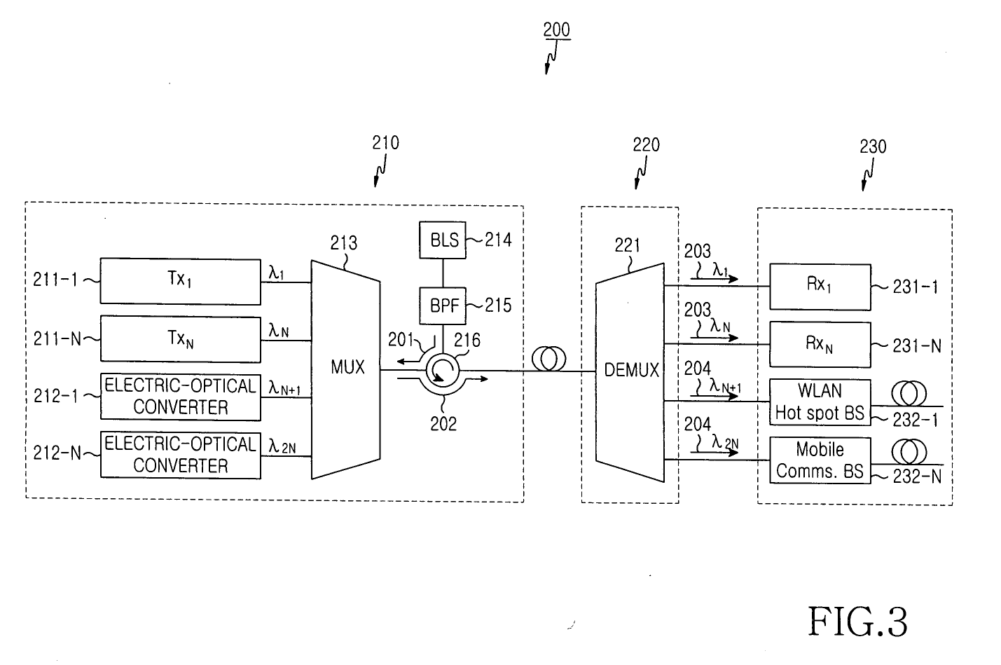

FIGS. 4A to 4D are graphs for explaining the light 201. The band-allocation module 215 passes the light having only a wavelength band of λ₁ to λ_{N} through the circulator 216. The wavelength band of λ₁ to λ_{N} is obtained by excluding a wavelength band of λₙ₊₁ to λ_{2N} overlapped with that of the second optical signals from a wavelength band of λ₁ to λ_{2N} of the light generated from the broadband light source 214.

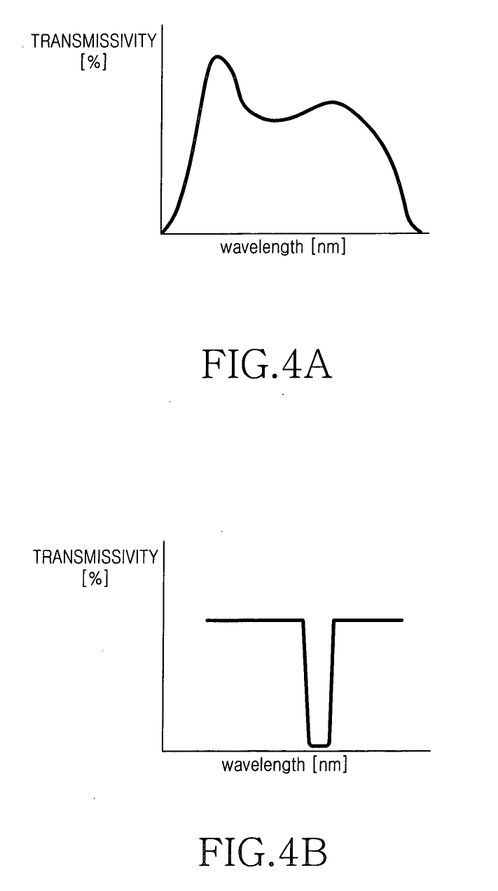

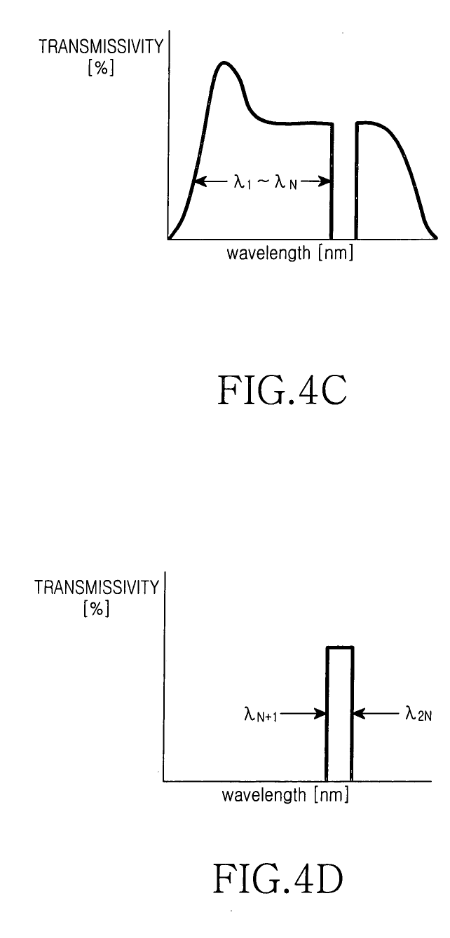

FIG. 5A is a block diagram illustrating the electric-optical conversion parts 212-1 to 212-N shown in FIG. 3. Each of the electric-optical conversion parts 212-1 to 212-N includes an RF converter 212a-N for generating a radio electric signal 303 and an electric-optical converter 212b-N for converting the radio electric signal 303 into the second optical signal 204.

The RF converter 212a-N up-converts baseband wireless transmission data 301 having a predetermined bandwidth into data having a predetermined RF frequency band and outputs a radio electric signal 303 having the RF frequency band to the electric-optical converter 212b-N. The electric-optical converter 212b-N is an element for converting the radio electric signal 303 into the second optical signal 204. The electric-optical converter 212b-N can employ a semiconductor laser, a semiconductor optical amplifier, an external optical modulator having a structure of a Mach-Zender interferometer, etc.

The RN 220 includes the demultiplexer 221 for demulitplexing an optical signal 202 which has been multiplexed in the CO 210.

Each of the subscribers 231-1 to 231-N is connected to the RN 220 and includes an optical detector for receiving a first optical signal with a corresponding wavelength from among the demultiplexed first optical signals. The optical detector may include a photo-diode.

FIG. 5B is a block diagram illustrating the radio relay stations 232-1 to 232-N shown in FIG. 3. Each of the radio relay stations 232-1 to 232-N may include an optical-electric converter 232a-N for converting a second optical signal with a corresponding wavelength from among the demultiplexed second optical signals 204 into a radio electric signal and an antenna 232b-N for wirelessly transmitting the radio electric signal received from the optical-electric converter 232a-N. The optical-electric converter 232a-N may include a photo-diode.

The radio relay stations 232-1 to 232-N may operate as hot-spot base stations for transmitting radio electric signals to a plurality of terminals including wireless LANs, or base stations for transmitting radio electric signals to a portable wireless terminal.

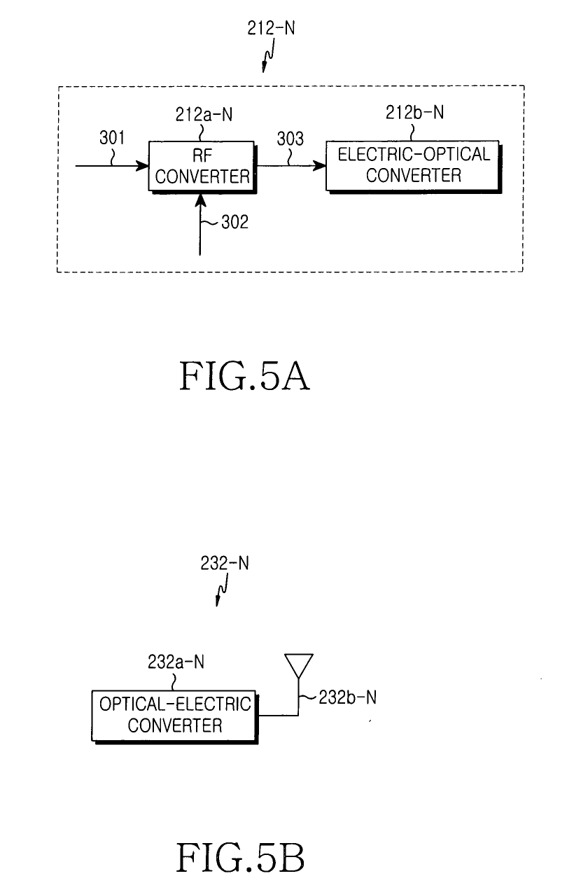

FIG. 6 illustrates an optical access network 300 according to a second embodiment of the present invention. The passive optical access network 300 for bi-directional communication includes a central office (CO) 310 for multiplexing first optical signals 301 for wire communication and second optical signals 302 for wireless communication, a remote node (RN) 320 connected to the CO 310 through an optical fiber and for demultiplexing a multiplexed downstream optical signal 303 received from the CO 310, a plurality of subscribers 330-1 to 330-N connected to the RN 320, and a plurality of radio relay stations 340-1 to 340-N connected to the RN 320. Each of the subscribers 330-1 to 330-N receives the first optical signal 301 with a corresponding wavelength from among the demultiplexed first optical signals and outputs a wavelength-locked upstream optical signal 306 to the CO 310 through the RN 320. Each of the radio relay stations 340-1 to 340-N converts the second optical signal 302 with a corresponding wavelength from among the demultiplexed second optical signals into a radio electric signal and wirelessly transmits the converted radio electric signal.

The CO 310 includes a broadband light source 314, a first multiplexer/demultiplexer 313, a plurality of downstream transmitters 311-1 to 311-N for generating the first wavelength-locked wire optical signals 301 for wire communication, a plurality of electric-optical conversion parts 312-1 to 312-N for generating the second optical signals 302 for wireless communication, a plurality of upstream optical detectors 317-1 to 317-N for detecting corresponding demultiplexed upstream optical signals 306, wavelength selecting couplers 316-1 to 316-N, an optical coupler 315, a first band-allocation module 318a and a second band-allocation module 318b.

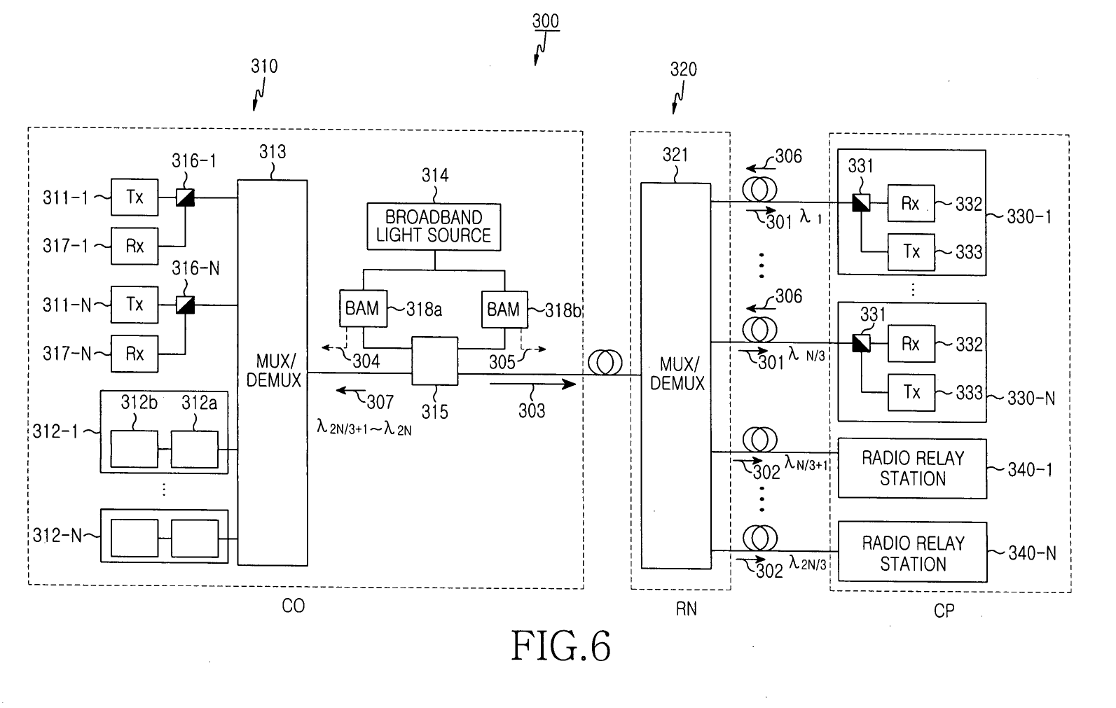

FIG. 7 is a graph showing a relationship between the broadband light source 314 and the first band-allocation module 318a and the second band-allocation module 318b shown in FIG. 6. The broadband light source 314 generates light with a broad wavelength band for performing wavelength locking with respect to each of subscribers 330-1 to 330-N. The first band-allocation module 318a outputs downstream light 304 having only a wavelength band of λ₁ to λ_{N/3}, which is not overlapped with a wavelength band of λ_{{N/3}+1} to λ_{2N/3} of the second optical signal 302 from a wavelength band of λ₁ to λ_{N} of the light, to the first multiplexer/demultiplexer 313 through the optical coupler 315. The second band-allocation module 318b is arranged between the broadband light source 314 and the optical coupler 315 and outputs only upstream light 305 having a wavelength band of λ_{{2N/3}+1} to λ_{N}, which is not overlapped with a wavelength band of λ_{{N/3}+1} to λ_{2N/3} of the second optical signal 302, to the optical coupler 315. The first band-allocation module 318a is also arranged between the broadband light source 314 and the optical coupler 315.

The first band-allocation module 318a suppresses noise in the electric-optical conversion parts 312-1 to 312-N by preventing a wavelength band of the first optical signal 301 for a wire relay from being overlapped with a wavelength band of the second optical signal 302 for a wireless relay.

The second band-allocation module 318b prevents wavelength bands of the second optical signals 302 from being overlapped with wavelength bands of the wavelength-locked upstream optical signals 306.

The first multiplexer/demultiplexer 313 multiplexes the first wavelength-locked optical signals 301 and the second optical signals 302, which are generated from the electric-optical conversion parts 312-1 to 312-N, into a downstream optical signal 303 and outputs the downstream optical signal to the RN 320. The first multiplexer/demultiplexer 313 demultiplexes upstream optical signals 307 multiplexed in the RN 320 and outputs the demultiplexed upstream optical signals to corresponding upstream optical detectors 317-1 to 317-N. The first multiplexer/demulitplexer 313 demultiplexes the downstream light 304 input through the optical coupler 315 into a plurality of incoherent channels having mutually different wavelengths and outputs the downstream optical signals to corresponding downstream transmitters 311-1 to 311-N. Each of the downstream transmitters 311-1 to 311-N generates the first optical signal 301 wavelength-locked by a corresponding incoherent channel.

Each of the wavelength selecting couplers 316-1 to 316-N outputs the first optical signal 301 generated by each of corresponding downstream transmitters 311-1 to 311-N to the first multiplexer/demultiplexer 313. Each of the wavelength selecting couplers 316-1 to 316-N also outputs the upstream optical signal demultiplexed by the first multiplexer/demultiplexer 313 to each of corresponding upstream optical detectors 317-1 to 317-N. The optical coupler 315 is arranged between the first multiplexer/demultiplexer 313 and the RN 320 and is connected to the broadband light source 314 so that the downstream light 304 is output to the first multiplexer/demultiplexer 313 and the upstream light 305 is output to the RN 320.

The RN 320 includes a second multiplexer/demultiplexer 321 for demultiplexing the multiplexed downstream optical signals 303 so_that each of the first optical signals 301 is output to each of corresponding subscribers 330-1 to 330-N and each of the second optical signals 302 is output to each of corresponding radio relay stations 340-1 to 340-N. The second multiplexer/demultiplexer 321 also multiplexes upstream optical signals 306 input from the subscribers 330-1 to 330-N so that the multiplexed upstream optical signals 307 are output to the CO 310. In addition, the second multiplexer/demultiplexer 321 demultiplexes the upstream light 305 into a plurality of incoherent channels having mutually different wavelengths so that the upstream light is output to the corresponding subscribers 330-1 to 330-N.

Each of the subscribers 330-1 to 330-N includes a downstream optical detector 332 for detecting a corresponding first optical signal 301, an upstream light source 333 for generating an upstream optical signal 306 wavelength-locked by a corresponding incoherent channel, and a wavelength selecting coupler 331 for outputting the upstream optical signal 306 to the RN 320 and outputting a corresponding first optical signal 301 received from the RN 320 to the downstream optical detector 332.

The downstream optical detector 332 may include a photo-diode. The upstream light source 333 may include a semiconductor optical amplifier or a Febry-Perot laser diode.

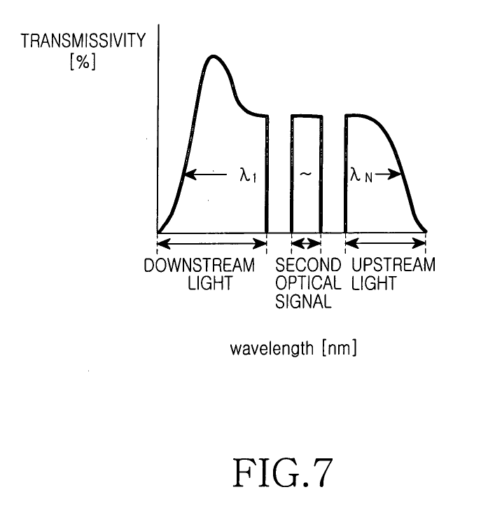

FIG. 8 illustrates an example of each radio relay station 340-N′ shown in FIG. 6. Each radio relay station 340-N′ includes a control part 410 for distribution of a corresponding second optical signal 302 received from the RN 320 and a radio signal transmitting part 420.

The radio signal transmitting part 420 includes an optical-electric converter 422 for converting a corresponding second optical signal 302 into a radio electric signal and an antenna 421 for transmitting the radio electric signal. The optical-electric converter 422 may include a photo-diode. The radio signal transmitting part 420 converts a corresponding second optical signal inputted according to directions of the control part 410 into a radio electric signal and transmits the radio electric signal to corresponding portable communication devices 401a, 401b, and 401c including wireless LAN terminals, which are positioned at a neighboring section.

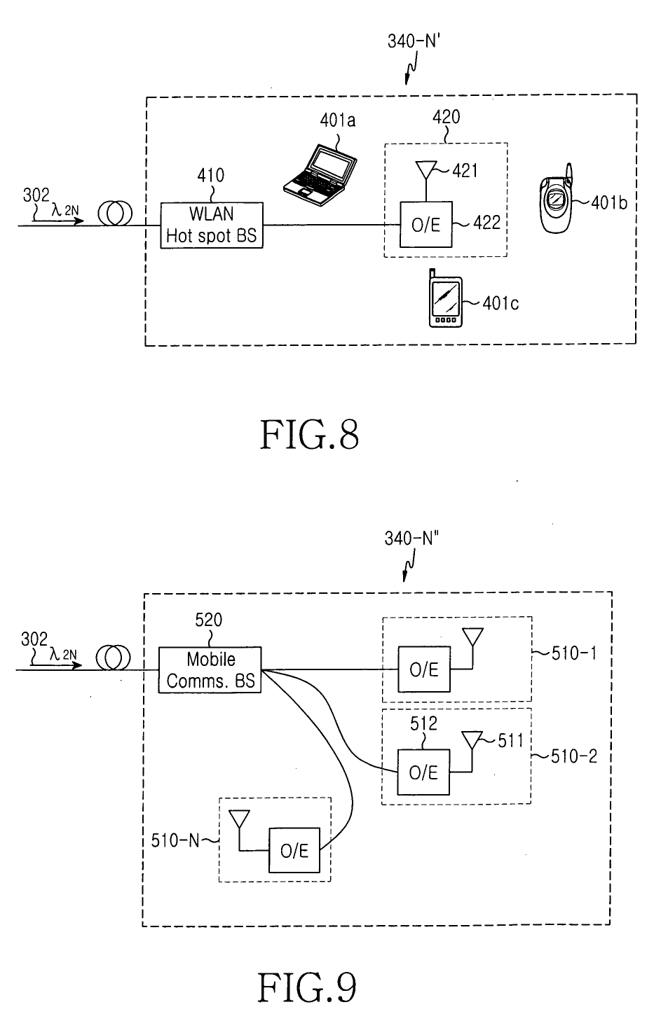

FIG. 9 illustrates an example of a radio relay station 340-N″ shown in FIG. 6. The radio relay station 340-N″ includes a control part 520 for distribution of a corresponding second optical signal 302 received from the RN 320 and a plurality of radio signal transmitting parts 510-1 to 510-N connected to the control part 520.

Each of the radio signal transmitting parts 510-1 to 510-N converts a corresponding second optical signal 302 received from the control part 520 into a radio electric signal and transmits the radio electric signal to a portable wireless terminal positioned at a neighboring section. Each of the radio signal transmitting parts 510-1 to 510-N includes an optical-electric converter 512 for converting a corresponding second optical signal 302 into a radio electric signal and an antenna 511 for transmitting the radio electric signal.

As described above, a wavelength division multiplexed passive optical access network may be integrated with a radio-over-fiber network for providing wireless services. This enables subscribers in a wireless network to receive ultra high speed broadband services without separately constructing a radio-over-fiber network. Accordingly, it is possible to reduce costs required for constructing the radio-over-fiber network and time required for expansion of the radio-over-fiber network.

Also, the limited wire network market is integrated with the rapidly-extending wireless network market, thereby enabling service providers to have improved profitability. Therefore, it is possible to provide services to subscribers at a reduced cost.

It is also noted that, in the passive optical access network having a wire network integrated with a wireless network, the maintenance and management for the wire network is integrated with that of the wireless network, thereby enabling costs required for the maintenance and management to be reduced.

While the invention has been shown and described with reference to certain embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A wavelength division multiplexed optical access network comprising:
a central office arranged to multiplex first optical signals for wire communication and second optical signals for wireless communication;
a remote node, connected to the central office through an optical fiber, arranged to demultiplex a multiplexed optical signal received from the central office;
a plurality of subscribers connected to the remote node, each subscriber receiving a first optical signal having a corresponding wavelength from among the demultiplexed first optical signals; and
a plurality of radio relay stations connected to the remote node, each radio relay station arranged to convert a second optical signal having a corresponding wavelength from among the demultiplexed second optical signals into a radio electric signal and wirelessly transmitting the radio electric signal.

2. The wavelength division multiplexed optical access network claimed in claim 1, wherein the central office includes;
a broadband light source;
a multiplexer arranged to multiplex the first optical signals and the second optical signals and to demultiplex light from the broadband light source into a plurality incoherent channels, each incoherent channel having each wavelength;
a plurality of light sources, connected to the multiplexer, arranged to generat a first optical signal wavelength-locked by a corresponding incoherent channel;
a plurality of electric-optical conversion parts, connected to the multiplexer, arranged to convert a radio electric signal into a second optical signal; and
a circulator arranged to output an optical signal multiplexed by the multiplexer to the remote node and to output the light input from the broadband light source to the multiplexer.

3. The wavelength division multiplexed optical access network claimed in claim 2, wherein the central office further includes a band-allocation module arranged between the circulator and the broadband light source, and the band-allocation module passes light having a wavelength band through the circulator, the wavelength band obtained by excluding a wavelength band overlapped with a wavelength band of the second optical signals from a wavelength band of the light inputted from the broadband light source.

4. The wavelength division multiplexed optical access network claimed in claim 1, wherein the remote node includes a demultiplexer arranged to demultiplex optical signals multiplexed in the central office.

5. The wavelength division multiplexed optical access network claimed in claim 1, wherein each subscriber is connected to the remote node and includes an optical detector arranged to receive a first optical signal having a corresponding wavelength from among the demultiplexed first optical signals.

6. The wavelength division multiplexed optical access network claimed in claim 1, wherein each radio relay station includes:
an optical-electric converter arranged to convert a second optical signal having a corresponding wavelength from among the demultiplexed second optical signals into a radio electric signal; and
an antenna arranged to wirelessly transmit the radio electric signal inputted from the optical-electric converter.

7. The wavelength division multiplexed optical access network claimed in claim 2, wherein the electric-optical conversion part includes:
an RF converter arranged to generate a radio electric signal with an RF frequency band into which an electric signal with a baseband is converted; and
an electric-optical converter arranged to convert the radio electric signal into a second optical signal.

8. The wavelength division multiplexed optical access network claimed in claim 6, wherein the optical-electric converter includes a photo-diode arranged to detect a corresponding second optical signal.

9. The wavelength division multiplexed optical access network claimed in claim 7, wherein the electric-optical converter includes a semiconductor laser arranged to convert a corresponding radio electric signal into a second optical signal.

10. The wavelength division multiplexed optical access network claimed in claim 7, wherein the electric-optical converter includes an external modulator arranged to convert a corresponding radio electric signal into a second optical signal.

11. A passive optical access network employing a wavelength locking method, the passive optical access network comprising:
a central office arranged to multiplex first optical signals for wire communication and second optical signals for wireless communication;
a remote node, connected to the central office through an optical fiber, arranged to demultiplex a multiplexed downstream optical signal received from the central office;
a plurality of subscribers connected to the remote node, each subscriber receiving a first optical signal having a corresponding wavelength from among the demulitiplexed first optical signals and outputting a wavelength-locked upstream optical signal to the central office through the remote node; and
a plurality of radio relay stations connected to the remote node, each radio relay station converting a second optical signal having a corresponding wavelength from among the demultiplexed second optical signals into a radio electric signal and wirelessly transmitting the radio electric signal.

12. The passive optical access network claimed in claim 11, wherein the central office includes:
a broadband light source;
a first multiplexer/demultiplexer arranged to multiplex the first optical signal and the second optical signal into a downstream optical signal so that the downstream optical signal is output to the remote node and to demultiplex the upstream optical signals;
a plurality of downstream transmitters arranged to generat a first wavelength-locked optical signal for wire communication;
a plurality of electric-optical conversion parts arranged to generat a second optical signal for wireless communication; and
a plurality of upstream optical detectors arranged to detect a corresponding upstream optical signal demultiplexed by the first multiplexer/demultiplexer.

13. The passive optical access network claimed in claim 12, wherein the central office include:
a plurality of wavelength selecting couplers arranged to output a first optical signal generated by a corresponding downstream light source to the first multiplexer/demultiplexer and output a corresponding upstream optical signal demultiplexed by the first multiplexer/demultiplexer to a corresponding upstream optical detector;
an optical coupler arranged between the first multiplexer/demultiplexer and the remote node so that a multiplexed downstream optical signal with an RF frequency band is output to the remote node and a multiplexed upstream optical signal is output to the first multiplexer/demultiplexer;
a first band-allocation module arranged to outputt downstream light having a predetermined wavelength band to the first multiplexer/demultiplexer through the optical coupler, the predetermined wavelength band not overlapped with a wavelength band of the second optical signal in a wavelength band of the light generated from the broadband light source; and
a second band-allocation module arranged to outputt upstream light having only a predetermined wavelength band to the remote node through the optical coupler, the predetermined wavelength band not overlapped with a wavelength band of the second optical signal in a wavelength band of the light generated from the broadband light source.

14. The passive optical access network claimed in claim 11, wherein the remote node includes a second multiplexer/demultiplexer arranged to demultiplexi the multiplexed downstream optical signals so that each first optical signal is output to a corresponding subscriber and each second optical signal is output to a corresponding radio generator and to multiplex upstream optical signals input from the subscribers so that the multiplexed upstream optical signals are output to the central office, and the second multiplexer/demultiplexer demultiplexes the upstream light into a plurality of incoherent channels for performing wavelength locking with respect to each subscriber.

15. The passive optical access network claimed in claim 11, wherein each subscriber includes:
a downstream optical detector arranged to detect a corresponding first optical signal;
an upstream light source arranged to generat a wavelength-locked upstream optical signal; and
a wavelength selecting coupler arranged to output the upstream optical signal to the remote node and output a corresponding first optical signal input from the remote node to the downstream optical detector.

16. The passive optical access network claimed in claim 11, wherein each radio relay station includes:
a control part arranged to control distribution of a corresponding second optical signal input from the remote node; and
a radio signal transmitting part arranged to convert a corresponding second optical signal input according to directions of the control part into a radio electric signal and transmitting the radio electric signal to a corresponding wireless LAN terminal positioned at a neighboring section.

17. The passive optical access network claimed in claim 16, wherein the radio signal transmitting part includes:
an optical-electric converter arranged to convert a corresponding second optical signal into a radio electric signal; and
an antenna arranged to transmit the radio electric signal.

18. The passive optical access network claimed in claim 17, wherein the optical-electric converter includes a photo-diode.

19. The passive optical access network claimed in claim 11, wherein each radio relay station includes:
a control part arranged to control distribution of a corresponding second optical signal input from the remote node; and
a plurality of radio signal transmitting parts connected to the control part, and
each radio signal transmitting part converts a corresponding second optical signal input from the control part into a radio electric signal and transmits the radio electric signal to a portable wireless terminal positioned at a neighboring section.

20. The passive optical access network claimed in claim 19, wherein the radio signal transmitting part includes:
an optical-electric converter arranged to convert a corresponding second optical signal into a radio electric signal; and
an antenna arranged to transmit the radio electric signal.

21. An optical access device comprising:
a remote node arranged to demultiplex a received multiplexed optical signal to a plurality of first optical signals and a plurality of second optical signals;
a plurality of subscribers connected to the remote node, each subscriber receiving a first optical signal having a corresponding wavelength from among the demultiplexed first optical signals; and
a plurality of radio relay stations connected to the remote node, each radio relay station arranged to convert a second optical signal having a corresponding wavelength from among the demultiplexed second optical signals into a radio electric signal and wirelessly transmitting the radio electric signal.

22. The optical access device claimed in claim 21, wherein the remote node includes a demultiplexer arranged to demultiplex the received multiplexed optical signals.

23. The optical access device claimed in claim 21, wherein each subscriber is connected to the remote node and includes an optical detector arranged to receive a first optical signal having a corresponding wavelength from among the demultiplexed first optical signals.

24. The optical access device claimed in claim 21, wherein each radio relay station includes:
an optical-electric converter arranged to convert a second optical signal having a corresponding wavelength from among the demultiplexed second optical signals into a radio electric signal; and
an antenna arranged to wirelessly transmit the radio electric signal input from the optical-electric converter.

25. The optical access device claimed in claim 24, wherein the optical-electric converter includes a photo-diode arranged to detect a corresponding second optical signal.
